(19) United States
(12) Patent Application Publication
(10) Pub. No.: US 2026/0042933 A1
(43) Pub. Date: Feb. 12, 2026

(54) Formulation For Simultaneous Rejuvenation And Protection Of The Interior Fibers And Exterior Surfaces Of Wood

(71) Applicant: Richard Winget, Doylestown, PA (US)

(72) Inventor: Richard Winget, Doylestown, PA (US)

(21) Appl. No.: 18/831,133

(22) Filed: Aug. 8, 2024

(51) Int. Cl. C09D 191/00; C08K 5/00; C08K 5/09; C08K 5/101; C08K 5/315; C08K 5/3475; C09D 5/10; C09D 5/14; C09D 7/48; C09D 7/63; C09D 167/08; C09D 175/04

(52) U.S. Cl. CPC C09D 191/005; C08K 5/0091; C08K 5/09; C08K 5/101; C08K 5/315; C08K 5/3475; C09D 5/103; C09D 5/14; C09D 7/48; C09D 7/63; C09D 167/08; C09D 175/04

(57) ABSTRACT

This invention relates to a formulation designed to be applied to wood surfaces of commercial, residential and real estate properties and functions to simultaneously rejuvenate and protect the internal fibers and the external surfaces of the wood.

### BACKGROUND OF THE INVENTION

Exterior wood surfaces can deteriorate due to a combination of natural factors, including but not limited to, sunlight, moisture, wind, heat, cold, chemicals and biological agents. The sun's ultraviolet rays break down the lignin in the wood's cellulose, causing a chemical reaction that changes the wood's color from its original hue to a silvery gray sheen. This process is called oxidation. Water molecules, from rain, snow, sleet and other sources of moisture, can easily penetrate the wood and cause problems. Dimensional change caused by the wetting and drying of wood generates surface stresses that cause checking and warping of timber. Water molecules swell wood thereby opening up inaccessible regions of the cell wall to degradation. Abrasion from windblown materials can also contribute to weathering of wood surfaces. Heat accelerates the chemical reactions involved in the weathering of wood. Exposure of wood to low temperatures and repeated freezing and thawing can also contribute to the checking of wood. An additional factor involved in the weathering of wood in cold climates is abrasion by wind-blown particles of ice. Windblown sand and salt can also cause similar, if less spectacular, abrasion of wood.

The main pollutants in the atmosphere are dust and smoke particles and volatile pollutants including sulfur compounds, ammonia, nitrogen oxides, carbon monoxide and saturated and unsaturated aliphatic and aromatic hydrocarbons and their derivatives. There have been few studies of the effects of these pollutants on the weathering of wood, and the experiments all suggest that the weathering of wood is more rapid in polluted than in unpolluted atmospheres. A wide range of microorganisms including fungi, bacteria, algae and lichens colonize weathered wood surfaces. Weathered wood is often visited by paper wasps, yellow jackets and hornets that mine weathered wood surfaces to obtain delignified wood fragments, which they use to construct their elaborate paper-like nests. Wood attacked by these insects has a stripy surface caused by the removal of strips of weathered wood, and the resulting contrast in color between gray weathered wood and the underlying unweathered wood.

The surface degradation that occurs when wood is used outdoors and above ground is termed weathering. Weathering should not be confused with decay caused by basidiomycete fungi. The most obvious features of weathered wood are its gray coloration and rough surface texture. Wood exposed to the weather changes color very rapidly. Light coloured woods, including most coniferous species, initially darken in color and become yellow or brown due to the accumulation of photodegraded lignin compounds in the wood. Dark coloured woods that are rich in phenolic extractives may fade initially before becoming yellow or brown. Irrespective of these initial color changes, wood exposed outdoors for 6 to 12 months (depending on climatic conditions) becomes gray due to the colonization of photodegraded, cellulose-rich, surface layers by dark colored staining fungi. Wood exposed outdoors in coastal (exposed to salt) or very drying environments where microbial activity is restricted is often an attractive silvery-gray color.

The most common method of protecting wood from weathering is through the use of coatings. Paints contain pigments that screen wood from solar radiation and because they form a film over the wood surface they prevent surface wetting and erosion. A correctly applied and maintained paint system including a primer and at least two topcoats can greatly reduce the deleterious effects of weathering on wood. However, paints are less effective at controlling decay and dimensional movement. Paints obscure wood's natural appearance and texture, and their tendency to trap water and encourage decay has led to increased use of penetrating water repellent stains as a means of protecting wood used outdoors. Stains contain a variety of additives to reduce the weathering of wood, including pigments and UV stabilizers to screen wood from solar radiation, hydrophobic additives to repel water and reduce checking, and a biocide to control the growth of microorganisms. Stains provide protection against weathering for only 2-5 years depending on wood species and surface texture, type and quantity of stain applied to the wood and degree of exposure to the weather. Another issue is that paints and to a lesser extent stains modify the appearance of wood. For end uses where it is important to retain the wood's natural color or texture the wood can be finished with a clear coating. Clear coatings, however, although they often contain UV stabilizers and a biocide, are limited in their ability to protect wood from weathering because they transmit light, which can degrade the underlying wood surface. Hence, clear coatings such as varnish perform badly on wood used outdoors and invariably fail by peeling and cracking within 6 months to 2 years of application. One means of increasing the performance of clear finishes on wood is to photostabilize the underlying wood surface prior to application of the clear finish. Pre-treatment of wood with dilute aqueous solutions of transition metal compounds (Cr, Mn, Ti, Cu), and particularly chromium trioxide can photo stabilize wood and increase the longevity of clear coatings applied subsequently to the wood. When wood is treated with chromium trioxide, lignin phenolic sub-units at wood surfaces are modified, producing oxidized lignin complexes with considerable light, thermal and solvolytic stability. It has been suggested that such complexes could function as ‘an ultraviolet screen’ protecting wood from the effects of the weather. However, health concerns about the use of metals and their environmentally unfriendly reputation, however, have discouraged commercial development of this concept. Metal containing wood preservatives may contain wax or oil; they also reduce the surface checking of wood exposed to the weather. Wax and oil emulsion additives are also added to metal-free preservatives to reduce the swelling and checking of wood used outdoors. The swelling of wood can be reduced by treatments that chemically or thermally modify the wood's molecular structure to reduce its affinity to water. Treatments that fall in to this category include acetylation, thermal modification and the impregnation of wood with resins. These treatments, which have all been commercialized, reduce the checking of wood exposed to the weather, but they retard rather than block surface photodegradation of wood.

US Publication No. 20130022829 to Marx relates to a wood product that requires bivalent copper and cationic surfactants. Copper in the soil destroys the mycorrhiza fungi that is crucial to plant health (helps the plants uptake nutrients). Copper, once it is in the soil, will continue to persist and cannot be removed from the soil. Unlike the prior art, the presently claimed invention excludes metals because of their health issues and lackluster performance. The present invention provides an environmentally friendly product and an embodiment, which is composed of FDA approved direct food contact ingredients.

US Publication No. 20070037001 to Gao et al. relates to a water repellent wood composition that requires wax and oil. Wax causes water to bead. Beaded water stays on the surface longer because the water is in bead form. The key to water resistance is lack of water penetration. Unlike the prior art, one embodiment of the present invention uses urethane/alkyd/tung oil, which reduces the surface energy of the wood allowing the water “bead” to flatten out when it lands on the surface. A flatter group of water molecules necessarily dries faster than a bead of water, as much as 100× faster. This is important because the less time water is on the surface the less opportunity it has to find microscopic cracks to invade and begin the degradation process.

### SUMMARY OF THE INVENTION

In one embodiment, the present invention provides for a formulation comprising active agents, and the active agents consisting of at least one drying oil selected from the group consisting of tung oil, linseed oil, sunflower oil, safflower oil, poppy oil, walnut oil, fish oil, corn oil, and soybean oil, at least one penetrant which is castor oil, hexadecanoic acid, soy palmitate, decanoic acid ester with 1, 2, 3-propanetriol octanoate, at least one UV inhibitor which is hydrophilic 2-(2-hydroxyphenyl)-benzotriazole, at least one biocide selected from the group consisting of zinc pyrithione, chlorothalonil, combinations and mixtures thereof, and at least one strength and elongation enhancer which is a polyurethane.

In another embodiment, the formulation is designed to be applied to the exterior of a wood surface and the polyurethane functions to improve adhesion of the UV inhibitor and to create surface protection to extend the aesthetic life of the wood. In yet another embodiment, the drying oil functions to encapsulate wood fibers, act as a protectant and binder of UV inhibitors, protecting against water, insect and light damage. In still another embodiment, the castor functions as a penetrant with antimicrobial activity. In another embodiment, the drying oil and penetrant of the present invention may seep or permeate from the surface to the internal fibers of the wood at about ¼ inches or greater in depth. In a further embodiment, the drying oil and penetrant of the present invention may seep or permeate from the surface to the internal fibers of the wood at about an inch or greater in depth.

In still yet another embodiment, the hexadecanoic acid synergizes with the drying oil such as tung oil in improving its wood penetrant capabilities, provides antimicrobial activity and resists insect damage. In a further embodiment, the soy palmitate works in synergy with the tung oil and the castor oil to improve the penetration of the formulation into the wood surfaces and cavities, and wets out the wood fiber allowing for better encapsulation of the tung oil to the wood fibers. In another further embodiment, the decanoic acid ester with 1, 2, 3-propanetriol octanoate synergizes with the tung oil in improving its wood penetrant capabilities, provides antimicrobial activity and assists in product cost reduction.

In yet a further embodiment, the hydrophilic 2-(2-hydroxyphenyl)-benzotriazole functions as a UV absorber and Hindered Amine Light Stabilizer. For purposes of this invention, the UV inhibitor can include UV absorbers, UV protectors, UV resistant additives, UV stabilizers, and other terms used in the paints, coatings, or construction building industry. In still a further embodiment, the biocide functions to protect the tung oil film which is the cohesiveness of the individual tung oil particles. For purposes of this invention, a biocide is any substance that destroys living things, especially a pesticide, fungicide, or herbicide.

In still yet a further embodiment, the drying oil is from about 2 to about 80% by weight of the formulation, the castor oil is from about 1 to about 70% by weight of the formulation, the hexadecanoic acid is from about 2 to about 90% by weight of the formulation, the soy palmitate is from about 1 to about 50% by weight of the formulation, the decanoic acid ester with 1, 2, 3-propanetriol octanoate is from about 1 to about 80% by weight of the formulation, the hydrophilic 2-(2-hydroxyphenyl)-benzotriazole is from about 0.01 to about 15% by weight of the formulation, at least one biocide is from about 0.05 to about 2% by weight of the formulation, and the polyurethane is from about 1 to about 40% by weight of the formulation.

In a further embodiment, the formulation of the present invention provides for a dual role of simultaneously rejuvenating internal fibers of the wood and protecting external surfaces of the wood. In another further embodiment, the drying oil and the penetrant rejuvenates the internal fibers of the wood and the biocide, the UV inhibitor, and the strength and elongation enhancer protects the external surface of the wood. In yet further embodiment, the hexadecanoic acid, soy palmitate, and decanoic acid ester with 1, 2, 3-propanetriol octanoate improve the wood penetrant capabilities of the drying oil and/or the castor oil.

In another embodiment, the present invention provides for a formulation comprising active agents, said active agents consisting of at least one drying oil selected from the group consisting of tung oil, linseed oil, sunflower oil, safflower oil, poppy oil, walnut oil, fish oil, corn oil, and soybean oil, at least one penetrant which is castor oil, hexadecanoic acid, soy palmitate, decanoic acid ester with 1, 2, 3-propanetriol octanoate, at least one UV inhibitor which is hydrophilic 2-(2-hydroxyphenyl)-benzotriazole, at least one biocide selected from the group consisting of zinc pyrithione, chlorothalonil, combinations and mixtures thereof, and an alkyd resin.

In a further embodiment, the formulation is designed to be applied to the exterior of a wood surface and said alkyd resin functions as to improve adhesion of the UV inhibitor and to create surface protection to extend the aesthetic life of the wood.

In another further embodiment, the alkyd resin functions to assist in the binding of UV absorbers, creates surface film, improves water resistance and assists in increasing the aesthetic longevity of the wood.

In yet another further embodiment, the drying oil is from about 2 to about 80% by weight of the formulation, the penetrant is from about 1 to about 70% by weight of the formulation, the hexadecanoic acid is from about 2 to about 90% by weight of the formulation, the soy palmitate is from about 1 to about 50% by weight of the formulation, the decanoic acid ester with 1, 2, 3-propanetriol octanoate is from about 1 to about 80% by weight of the formulation, the hydrophilic 2-(2-hydroxyphenyl)-benzotriazole is from about 0.01 to about 15% by weight of the formulation, at least one biocide is from about 0.05 to about 2% by weight of the formulation, and the alkyd resin is from about 1 to about 40% by weight of the formulation.

In a further embodiment, the formulation provides for a dual and simultaneous role of internally rejuvenating fibers of the wood and externally protecting surfaces of the wood. In another further embodiment, the drying oil and the penetrant internally rejuvenates the fibers of the wood and the biocide, the UV inhibitor, and the alkyd resin externally protects the surface of the wood.

In still another further embodiment, the present invention relates to a formulation comprising active agents, and the active agents consisting of at least one drying oil selected from the group consisting of tung oil, linseed oil, sunflower oil, safflower oil, poppy oil, walnut oil, fish oil, corn oil, and soybean oil, at least one penetrant which is castor oil, soy palmitate, and decanoic acid ester with 1, 2, 3-propanetriol octanoate. In another embodiment, the formulation is designed to be applied to the exterior of a wood surface and said formulation is composed of FDA approved direct food contact ingredients.

In a further embodiment, the drying oil is from about 2 to about 80% by weight of the formulation, the penetrant or castor oil is from about 1 to about 70% by weight of the formulation, the soy palmitate is from about 1 to about 50% by weight of the formulation, and the decanoic acid ester with 1, 2, 3-propanetriol octanoate is from about 1 to about 80% by weight of the formulation.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

The present invention provides a formulation that functions as a rejuvenating and protecting agent that is designed to be applied to wood surfaces of commercial, residential and real estate properties. The combination and synergies of the ingredients in the presently claimed invention, uses the known capillary action of the lignin and wood cellulose to introduce oils. The combination of oils in this invention penetrate each individual fibers in order to reintroduce oils which significantly increase the flexibility of the wood. Wood that is flexible has greater resilience to thermal and moisture related expansion and contraction.

### Tung Oil

Tung oil or China wood oil is a drying oil obtained by pressing the seed from the nut of the tung tree (Vernicia fordii). Tung oil hardens upon exposure to air (through polymerization), and the resulting coating is transparent and has a deep, almost wet look. Tung oil is used for finishing and protecting wood, and after numerous coats, the finish can even look plastic-like. Related oils include tung oil, linseed oil, sunflower oil, safflower oil, poppy oil, walnut oil, fish oil, corn oil, and soybean oil. In this invention, drying oil functions to encapsulate wood fibers and is a protectant and binder of UV inhibitors, and the drying oil protects against water, insect and light damage.

### Castor Oil

Castor oil is a vegetable oil pressed from castor beans. It is a colorless or pale yellow liquid with a distinct taste and odor. It includes a mixture of triglycerides in which about 90% of fatty acids are ricinoleates. Castor oil is well known as a source of ricinoleic acid, a monounsaturated, 18-carbon fatty acid. Among fatty acids, ricinoleic acid is unusual in that it has a hydroxyl functional group on the 12th carbon atom. This functional group causes ricinoleic acid (and castor oil) to be more polar than most fats. The chemical reactivity of the alcohol group also allows chemical derivatization that is not possible with most other seed oils. Oleic acid and linoleic acid are the other significant components. Castor oil and its derivatives are used in the manufacturing of soaps, lubricants, hydraulic and brake fluids, paints, dyes, coatings, inks, cold-resistant plastics, waxes and polishes, nylon, and perfumes. In this present invention, castor oil functions as a penetrant with antimicrobial activity.

### Hexadecanoic Acid

Hexadecanoic acid or palmitic acid is a fatty acid with a 16-carbon chain. It is the most common saturated fatty acid found in animals, plants and microorganisms. Its chemical formula is CH3(CH2)14COOH, and its C:D ratio (the total number of carbon atoms to the number of carbon-carbon double bonds) is 16:0. It is a major component of palm oil from the fruit of Elaeis guineensis (oil palms), making up to 44% of total fats.

In this presently claimed invention, hexadecanoic acid synergizes with said at least one drying oil in improving its wood penetrant capabilities, provides antimicrobial activity and resists insect damage.

### Soy Palmitate

Soy or soybean palmitate is an ester or salt of Hexadecanoic acid or palmitic acid. Soy-based sealers have a superior ability to penetrate and protect a variety of porous substrate surfaces such as concrete, wood and grout. Biobased sealers create an integral bond and seal that allow the substrate to breathe while providing outstanding repellency. Because these sealers are nontoxic and high performing, they meet both consumer and producer needs.

As it relates to this invention, soy palmitate works in synergy with the drying oil such as tung oil and the castor oil to improve the penetration of the formulation into the wood surfaces and cavities, and wets out the wood fiber allowing for better encapsulation of the drying oil to the wood fibers.

Decanoic Acid Ester with 1, 2, 3-Propanetriol Octanoate

Decanoic acid ester with 1,2,3-propanetriol octanoate, also known as caprylic/capric triglyceride, is a medium chain triglyceride oil with the molecular formula CHO and an average mass of 408.570 Da. It's a mixed triester of glycerin and caprylic and capric acids.

As it relates to this present invention, decanoic acid ester with 1, 2, 3-propanetriol octanoate synergizes with the drying oil in improving its wood penetrant capabilities, provides antimicrobial activity and assists in product cost reduction.

### 2-(2-Hydroxyphenyl)-Benzotriazole

2-(2-Hydroxyphenyl)-2H-benzotriazoles, also referred to as phenolic benzotriazoles, are an important class of UV absorbers comprising the benzotriazole building block. The molecules are composed of substituted benzotriazoles with a phenyl group in the 2-position, which carries a hydroxyl group in the ortho-position. In this presently claimed invention, 2-(2-hydroxyphenyl)-benzotriazole functions as a UV absorber and light stabilizer.

### Zinc Pyrithione

Zinc pyrithione (or pyrithione zinc) is a coordination complex of zinc. It has fungistatic (inhibiting the division of fungal cells) and bacteriostatic (inhibiting bacterial cell division) properties. The pyrithione ligands, which are formally monoanions, are chelated to Zn²⁺ via oxygen and sulfur centers. In the crystalline state, zinc pyrithione exists as a centrosymmetric dimer (see FIGURE), where each zinc is bonded to two sulfur and three oxygen centers.^{[3]} In solution, however, the dimers dissociate via scission of one Zn—O bond. Pyrithione is the conjugate base derived from 2-mercaptopyridine-N-oxide, a derivative of pyridine-N-oxide. Because of its low solubility in water (8 ppm at neutral pH), zinc pyrithione is suitable for use in outdoor paints and other products that protect against mildew and algae. It is an algaecide. It is chemically incompatible with paints relying on metal carboxylate curing agents. When it is used in latex paints with water containing much iron, a sequestering agent that preferentially binds the iron ions is needed. It is decomposed by ultraviolet light slowly, providing years of protection in direct sunlight. For purposes of the present invention, the biocide functions to protect the drying oil film, which is the cohesiveness of the individual drying oil particles.

### Polyurethane

Polyurethane refers to a class of polymers composed of organic units joined by carbamate (urethane) links. A polyurethane is typically produced by reacting a polymeric isocyanate with a polyol. Since a polyurethane contains two types of monomers, which polymerize one after the other, they are classed as alternating copolymers. Both the isocyanates and polyols used to make a polyurethane contain two or more functional groups per molecule.

Polyurethane can be used as a varnish that can be applied to wood products to protect them from scratches, water, dust and wear and tear. It can also give wood a smooth, glossy finish. Polyurethane is available in different types, including oil-based and water-based, and each type has different properties:

Oil-based: This type of polyurethane is more durable than water-based and can withstand heat better. It can give wood a rich golden tone, but it will develop an amber tint over time. Oil-based polyurethane is a good choice for projects like kitchen tables and countertops.
Water-based: This type of polyurethane is clear, low-odor, and dries quickly. It's recommended for surfaces that are exposed to the elements or heat less often, such as desks, bookcases, and end tables. Water-based polyurethane helps maintain wood's natural lightness, but it may require more coats than oil-based polyurethane.

For purposes of this presently claimed invention, polyurethane functions to improve adhesion of the UV inhibitor and to create surface protection to extend the aesthetic life of the wood.

### Alkyd Resin

An alkyd is a polyester resin modified by the addition of fatty acids and other components. Alkyds are derived from polyols and organic acids including dicarboxylic acids or carboxylic acid anhydride and triglyceride oils. The term alkyd is a modification of the original name “alcid”, reflecting the fact that they are derived from alcohol and organic acids. The inclusion of a fatty acid confers a tendency to form flexible coatings. Alkyds are used in paints, varnishes and in molds for casting. They are the dominant resin or binder in most commercial oil-based coatings.

In this invention, the alkyd resin functions to assist in the penetration of the formulation, the binding of UV absorbers, creates surface film, improves water resistance and assists in increasing the aesthetic longevity of the wood.

In one of the embodiments of the present invention, Table 1, set forth below, represents a an exterior surface rejuvenating and protecting formulation:

TABLE 1

| Active Agents: | % By Weight of Formulation |
|---|---|
| Tung oil | from about 2 to about 80% |
| Castor oil | from about 1 to about 70% |
| Hexadecanoic acid | from about 2 to about 90% |
| Soy palmitate | from about 1 to about 50% |
| Decanoic acid ester with | from about 1 to about 80% |
| 1,2,3-propanetriol octanoate | |
| Hydrophilic 2-(2- | from about 0.01 to about 15% |
| hydroxyphenyl)-benzotriazole | |
| Zinc pyrithione | from about 0.05 to about 2% |
| Polyurethane | from about 1 to about 40% |

In another embodiment, Table 2, set forth below, relates to another embodiment of the formulation:

TABLE 2

| Active Agents: | % By Weight of Formulation |
|---|---|
| Linseed oil | from about 2 to about 80% |
| Castor oil | from about 1 to about 70% |
| Hexadecanoic acid | from about 2 to about 90% |
| Soy palmitate | from about 1 to about 50% |
| Decanoic acid ester with | from about 1 to about 80% |
| 1,2,3-propanetriol octanoate | |
| Hydrophilic 2-(2- | from about 0.01 to about 15% |
| hydroxyphenyl)-benzotriazole | |
| Chlorothalonil | from about 0.05 to about 2% |
| Polyurethane | from about 1 to about 40% |

In still another embodiment, Table 3, set forth below, relates to another embodiment of the present invention:

TABLE 3

| Active Agents: | % By Weight of Formulation |
|---|---|
| Safflower oil | from about 2 to about 80% |
| Castor oil | from about 1 to about 70% |
| Hexadecanoic acid | from about 2 to about 90% |
| Soy palmitate | from about 1 to about 50% |
| Decanoic acid ester with | from about 1 to about 80% |
| 1,2,3-propanetriol octanoate | |
| Hydrophilic 2-(2- | from about 0.01 to about 15% |
| hydroxyphenyl)-benzotriazole | |
| Zinc pyrithione | from about 0.05 to about 2% |
| Alkyd resin | from about 1 to about 40% |

In still another embodiment, Table 4, set forth below, relates to another embodiment of the present invention:

TABLE 4

| Active Agents: | % By Weight of Formulation |
|---|---|
| Poppy oil | from about 2 to about 80% |
| Castor oil | from about 1 to about 70% |
| Hexadecanoic acid | from about 2 to about 90% |
| Soy palmitate | from about 1 to about 50% |
| Decanoic acid ester with | from about 1 to about 80% |
| 1,2,3-propanetriol octanoate | |
| Hydrophilic 2-(2- | from about 0.01 to about 15% |
| hydroxyphenyl)-benzotriazole | |
| Chlorothalonil | from about 0.05 to about 2% |
| Alkyd resin | from about 1 to about 40% |

In still another embodiment, Table 5, set forth below, relates to another embodiment of the present invention:

TABLE 5

| Active Agents: | % By Weight of Formulation |
|---|---|
| Tung oil | from about 2 to about 80% |
| Castor oil | from about 1 to about 70% |
| Soy palmitate | from about 1 to about 50% |
| Decanoic acid ester with | from about 1 to about 80% |
| 1,2,3-propanetriol octanoate | |

Among those benefits and improvements that have been disclosed, other objects and advantages of this invention will become apparent from the following description taken in conjunction with the accompanying drawings. The tables and examples constitute a part of this specification and include exemplary embodiments of the present invention and illustrate various objects and features thereof.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A formulation comprising active agents, said active agents consisting of at least one drying oil selected from the group consisting of tung oil, linseed oil, sunflower oil, safflower oil, poppy oil, walnut oil, fish oil, corn oil, and soybean oil, at least one penetrant which is castor oil, hexadecanoic acid, soy palmitate, decanoic acid ester with 1, 2, 3-propanetriol octanoate, at least one UV inhibitor which is hydrophilic 2-(2-hydroxyphenyl)-benzotriazole, at least one biocide selected from the group consisting of zinc pyrithione, chlorothalonil, combinations and mixtures thereof, and at least one strength and elongation enhancer which is a polyurethane.

2. The formulation of claim 1 wherein said formulation is designed to be applied to the exterior of a wood surface and said polyurethane functions to improve adhesion of the UV inhibitor and to create surface protection to extend the aesthetic life of the wood.

3. The formulation of claim 1 wherein said at least one drying oil functions to encapsulate wood fibers and is a protectant and binder of UV inhibitors, said at least one oil protects against water, insect and light damage.

4. The formulation of claim 1 wherein said at least one penetrant functions as a penetrant with antimicrobial activity.

5. The formulation of claim 1 wherein said hexadecanoic acid synergizes with said at least one drying oil in improving its wood penetrant capabilities, provides antimicrobial activity and resists insect damage.

6. The formulation of claim 1 wherein said soy palmitate works in synergy with said at least one drying oil and said at least one penetrant to improve the penetration of said formulation into the wood surfaces and cavities, and wets out the wood fiber allowing for better encapsulation of said at least one drying oil to the wood fibers.

7. The formulation of claim 1 wherein said decanoic acid ester with 1, 2, 3-propanetriol octanoate synergizes with said at least one drying oil in improving its wood penetrant capabilities, provides antimicrobial activity and assists in product cost reduction.

8. The formulation of claim 1 wherein said hydrophilic 2-(2-hydroxyphenyl)-benzotriazole functions as a UV absorber and Hindered Amine Light Stabilizer.

9. The formulation of claim 1 wherein said at least one biocide functions to protect said at least one drying oil film.

10. The formulation of claim 1 wherein said at least one drying oil is from about 2 to about 80% by weight of said formulation, said at least one penetrant is from about 1 to about 70% by weight of said formulation, said hexadecanoic acid is from about 2 to about 90% by weight of said formulation, said soy palmitate is from about 1 to about 50% by weight of said formulation, said decanoic acid ester with 1, 2, 3-propanetriol octanoate is from about 1 to about 80% by weight of said formulation, said hydrophilic 2-(2-hydroxyphenyl)-benzotriazole is from about 0.01 to about 15% by weight of said formulation, said at least one biocide is from about 0.05 to about 2% by weight of said formulation, and said polyurethane is from about 1 to about 40% by weight of said formulation.

11. The formulation of claim 2 wherein said formulation provides for a dual role of simultaneously rejuvenating internal fibers of the wood and protecting external surfaces of the wood.

12. The formulation of claim 11 wherein said at least one drying oil and said at least one penetrant rejuvenates the internal fibers of the wood and said at least one biocide, said at least one UV inhibitor, and said at least one strength and elongation enhancer protects the external surface of the wood.

13. A formulation comprising active agents, said active agents consisting of at least one drying oil selected from the group consisting of tung oil, linseed oil, sunflower oil, safflower oil, poppy oil, walnut oil, fish oil, corn oil, and soybean oil, at least one penetrant which is castor oil, hexadecanoic acid, soy palmitate, decanoic acid ester with 1, 2, 3-propanetriol octanoate, at least one UV inhibitor which is hydrophilic 2-(2-hydroxyphenyl)-benzotriazole, at least one biocide selected from the group consisting of zinc pyrithione, chlorothalonil, combinations and mixtures thereof, and an alkyd resin.

14. The formulation of claim 13 wherein said formulation is designed to be applied to the exterior of a wood surface and said alkyd resin functions as to improve adhesion of the UV inhibitor and to create surface protection to extend the aesthetic life of the wood.

15. The formulation of claim 13 wherein said alkyd resin functions to assist in the binding of UV absorbers, creates surface film, improves water resistance and assists in increasing the aesthetic longevity of the wood.

16. The formulation of claim 13 wherein said at least one drying oil is from about 2 to about 80% by weight of said formulation, said at least one penetrant is from about 1 to about 70% by weight of said formulation, said hexadecanoic acid is from about 2 to about 90% by weight of said formulation, said soy palmitate is from about 1 to about 50% by weight of said formulation, said decanoic acid ester with 1, 2, 3-propanetriol octanoate is from about 1 to about 80% by weight of said formulation, said hydrophilic 2-(2-hydroxyphenyl)-benzotriazole is from about 0.01 to about 15% by weight of said formulation, said at least one biocide is from about 0.05 to about 2% by weight of said formulation, and said alkyd resin is from about 1 to about 40% by weight of said formulation.

17. The formulation of claim 13 wherein said formulation provides for a dual and simultaneous role of internally rejuvenating fibers of the wood and externally protecting surfaces of the wood.

18. The formulation of claim 13 wherein said at least one drying oil and said at least one penetrant internally rejuvenates the fibers of the wood and said at least one biocide, said at least one UV inhibitor, and said alkyd resin externally protects the surface of the wood.

19. A formulation comprising active agents, said active agents consisting of at least one drying oil selected from the group consisting of tung oil, linseed oil, sunflower oil, safflower oil, poppy oil, walnut oil, fish oil, corn oil, and soybean oil, at least one penetrant which is castor oil, soy palmitate, and decanoic acid ester with 1, 2, 3-propanetriol octanoate.

20. The formulation of claim 19 wherein said formulation is designed to be applied to the exterior of a wood surface and said formulation is composed of FDA approved direct food contact ingredients.

21. The formulation of claim 19 wherein said at least one drying oil is from about 2 to about 80% by weight of said formulation, said at least one penetrant is from about 1 to about 70% by weight of said formulation, said soy palmitate is from about 1 to about 50% by weight of said formulation, and said decanoic acid ester with 1, 2, 3-propanetriol octanoate is from about 1 to about 80% by weight of said formulation.
